(19) United States
(12) Patent Application Publication
(10) Pub. No.: US 2013/0275335 A1
(43) Pub. Date: Oct. 17, 2013

(54) SYSTEM AND METHOD FOR SCREENING OF STOCKS

(71) Applicant: Brian KELLY, Wicklow (IE)

(72) Inventor: Brian KELLY, Wicklow (IE)

(21) Appl. No.: 13/863,581

(22) Filed: Apr. 16, 2013

(30) Foreign Application Priority Data
Apr. 17, 2012 (GB) GB1206706.2

(51) Int. Cl. G06Q 40/06

(52) U.S. Cl. CPC G06Q 40/06
USPC 705/36 R

(57) ABSTRACT

A method for selecting companies for potential investment from a universe of companies is disclosed. The method includes a first screening step in which each company within the universe is subject to an analysis that determines the change of its results over a period of time. Subsequently, those companies that have a change in performance that exceeds a threshold are selected for a second screening step in which those of the selected that have characteristics that meet specified requirements are presented to a user as prospects for investment.

### BACKGROUND TO THE INVENTION

1. Field of the Invention

This invention relates to a system and method for screening of stocks, with the aim of assisting a person in choosing stocks in which to invest.

2. Summary of the Prior Art

When picking stocks in which to invest, many small investors follow their instincts and market commentators. In contrast, institutional investors and fund managers have developed sophisticated techniques, including automated models that assist in their choice of investments. Institutional investors have invested in technology and analytic resources required to develop models that will give them an extra “edge” in the market. As a result, today's institutional investor has access to an extensive range of models, fed by a wide array of data sources, and supported by internal and external qualitative information and research.

Although institutional investors guard their models carefully, it is inevitable that, over time, common techniques will become known publicly, and, as a result, a number of standardised models have evolved, such as value investing, income investing, GARP, amongst others. This standardisation has inevitably resulted in most models being derived from an underlying “standard”.

A limitation of standard methods for assessment of companies as prospects for investment is that they use the last reported company performance data as a coarse filter to generate a shortlist of companies that will then be examined more closely. However, this can exclude companies that generally perform well, but have had a one-off poor performance report (which could, for example, arise because of capital investment in new products) and include companies that have a poor track record, but have had a one-off profitable accounting period.

It has been recognised that looking at the trend of a company's profits over a period of time can give a more accurate indication of its performance, and this has been used to analyse selected companies that have been selected by a coarse filter. However, the amount of data that must be analysed has proven to be dissuasive to their use in analysing more than a small number of companies.

### SUMMARY OF THE INVENTION

An aim of the present invention is to provide a system that can present information to enable an investor to make better decisions when deciding where to make investments.

To this end, the present invention provides a method for selecting companies for potential investment from a universe of companies, the method including a first screening step in which each company within the universe is subject to an analysis that determines the change of its results over a period of time, and those companies that have a change in performance that exceeds a threshold are selected for a second screening step in which those of the selected that have characteristics that meet specified requirements are presented to a user as prospects for investment.

Thus, a wide range of companies are subject to historical analysis, which can provide improved analysis of the entire universe of companies under consideration. Once companies that have a positive historic track record have been identified, these are then subject to a further analysis to determine their suitability. This is a reversal of the standard procedures used to identify potentially investable companies.

The results analysed typically includes one or more of the return-on-equity, net profit-margin, return-on-invested-capital, return-on-capital-employed, return-on-assets, debt-to-equity or current ratio of the company which is a ratio of the net income to owners' equity. The change in the results is typically calculated as a regression of a plurality of historical results. The regression may be one of a linear, exponential, logarithmic, polynomial, power or moving averages regression. The regression may be performed over a set of results that represent the performance of the company at equally-spaced historical time intervals. For example, the period of time may be several calendar quarters, in which case the results may represent quarterly performance data of the company. The period of time may be several calendar years, in which case the results may represent annual performance data of the company.

In the second screening step, screened characteristics include data relating to the performance of each company identified in the first screening step. In the second screening step, characteristics may alternatively or additionally include one or more flags that identify specific characteristics of each company.

A according embodying the invention may further include presenting to a user a graphical display that shows the variation of a plurality of results of a company over time. Alternatively or additionally, it may further include presenting to a user a graphical display that shows the variation of a plurality of results from a plurality of companies (for example, the average of such results) over time. The plurality of companies may be those in which a user has invested, to enable an investor to assess the performance of their investments.

Typically, a method embodying the invention further includes presenting to a user a graphical display that identifies those companies that have been assessed as having a favourable level of performance.

From a second aspect, the invention provides a computer software product that performs a method in accordance with the first aspect of the invention when executed on a computer hardware platform.

### BRIEF DESCRIPTION OF THE DRAWINGS

In the drawings:

FIG. 1 is a screenshot of a GUI display in a known software system for assisting in the selection of stocks for investment;

FIG. 2 is a graph that illustrates analysis of companies using known methods and using slope screening, in an embodiment of the invention;

FIG. 3 is a histogram showing the distribution of the return-on-equity slopes of the S&P 1500 index constituents;

FIG. 4 is a histogram showing the distribution of the net profit margin slopes of the S&P 1500 index constituents;

FIG. 5 is a screenshot of a display of a software program that implements the invention in which a user can select search criteria;

FIG. 6 illustrates the concept of a margin of safety, applied to an assessment of the value of a company;

FIG. 7 is a diagrammatic representation of a display of multiple slopes for a selected company; and

FIG. 8 shows a “leaderboard” of companies that have been identified as potential investments by a system embodying the invention.

### DETAILED DESCRIPTION OF AN EMBODIMENT

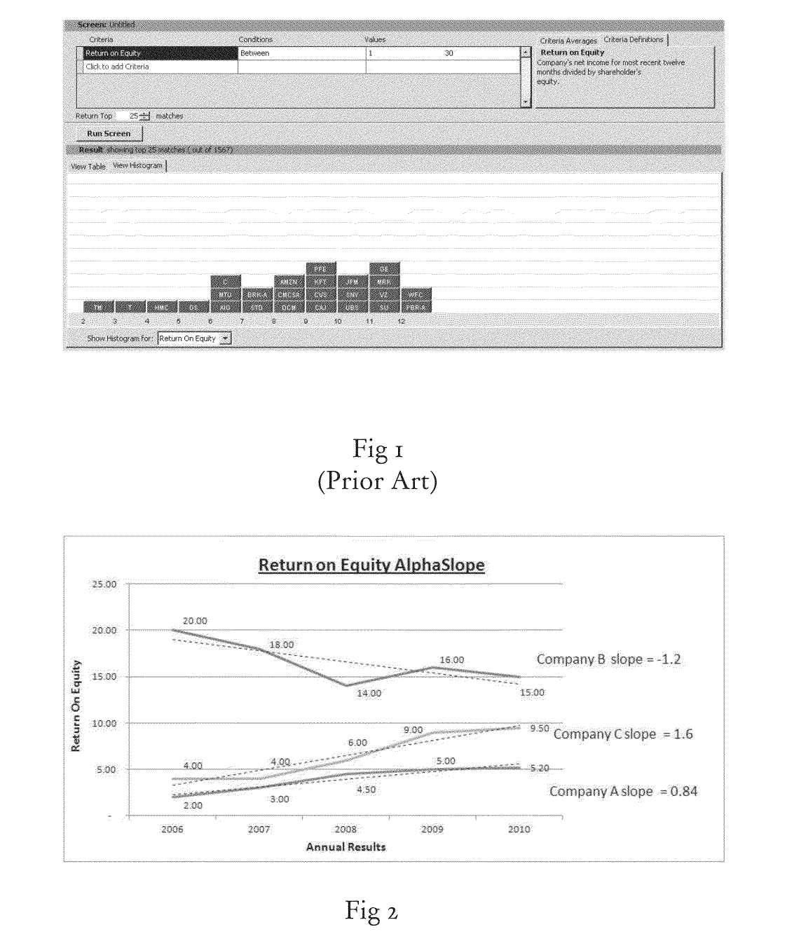

Existing stock screening tools typically select companies based upon either their latest data or in some cases, such as the price/earnings growth ratio, an average over time (e.g., a 5-year average) or an average compared with a benchmark, such as the S&P 500 index. In computer-assisted stock selection systems, this information is presented to a user in a simple histogram in a GUI display, as shown in FIG. 1. In FIG. 2, the return-on-equity figures for three companies are being compared. The companies might be part of the same sector or not. Using this type of screening Company B has the highest value, followed by Company C, and then company A.

### Introduction to the System

The object of this embodiment is to present to a user a selection of companies worthy of consideration for investment in their stock.

A system embodying the invention comprises a software application that executes on a suitable hardware platform with access to historical company data. The software presents a user with an interface that can be operated by a user to input conditions that will be used when screening data and on which data representing the results of the screening will be displayed.

An important concept underlying this embodiment is slope scanning. Conventional stock screening is based upon the latest available data, averages (such as price-to-earnings-to-growth—PEG), or index or sector comparisons. In contrast, slope scanning selects companies from a universe of companies by selecting those that show improvement over time. This screening can be based on a number of criteria, including one or more ratios, a specific company data point or points, or a combination of the two.

Intrinsic value screening also forms a part of a ‘value investing’ model, which the present invention assists in implementing. In broad terms, intrinsic value is the value of a company based on an underlying perception of its true value, including many aspects of its business, in terms of both tangible and intangible factors. In the case of value investing in the context of the present embodiment, the system calculates intrinsic value using the discounted value of future cash flows. There are a number of alternative ways that might be used to calculate the intrinsic value of a company, as will be discussed in due course.

Once companies have been screened by analysis of performance slopes, it is possible to screen for valuable companies is by using company figures, such as a past year's net profit margin. A final step in the screening process is that one or more specific flags can be used to remove certain companies from the screening results, for instance if the company is an investment trust.

### Slope Screening

Slope screening selects companies based on their performance over time. The process of slope screening measures the gradient of the change in the return on equity over a set time period (e.g., 5 years). Applying this method to the company data previously discussed with reference to the data set forth in FIG. 2, Company C returns the highest value, Company A the second-highest value, and company B, the lowest value. In its simplest form the slope of a linear regression line is b, where x and y are the sample means of known x values and known y values, given by:

$$b = \begin{matrix}\sum ( x - \overline{x} ) ( y - \overline{y} ) \\ \sum {( x - \overline{x} )}^{2}\end{matrix} \qquad ( 1 )$$

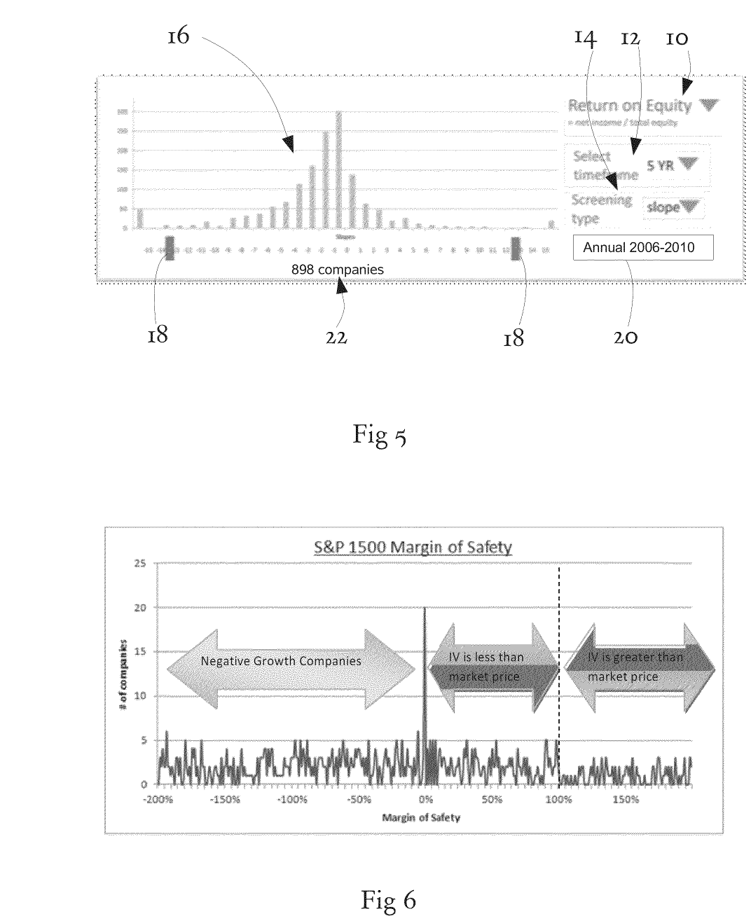

To select y-values a user chooses a stock universe to be screened e.g., S&P 1500. X-values can be configured by selecting the number and type of data points to be included in the analysis. As an example, to screen from a recent results set (for instance, 2011 annual report, or Form 10-K, required by the US Securities and Exchange Commission for US companies,) back 5 years the user would select the option ‘5 Yrs’ in the interface of FIG. 5. To screen from the latest quarterly results back 8 quarters the user would select the ‘8 Qtrs’ option in the interface of FIG. 5. This approach could also be applied to monthly data, such as a “trailing twelve months” (TTM) sample.

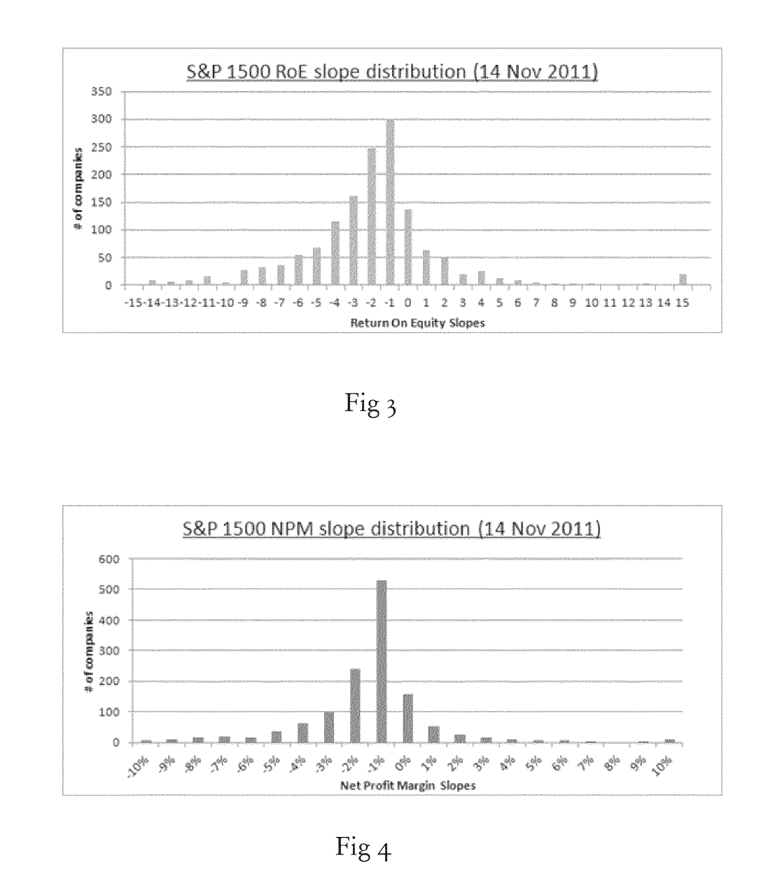

Once the user has entered the specification of the screen that should be performed, the system scans historical company performance data to find companies that accord with the specification. Results are sorted into meaningful groups based on the frequency of companies having a particular range of slopes. A sample distribution of companies is shown in the histogram of FIG. 3, which represents the S&P 1500 return-on-equity slope histogram and the histogram of FIG. 4, which represents the S&P 1500 net profit margin slope histogram.

This linear method for determining the slope will be used within embodiments of the invention. Additional methods will also be available in alternative embodiments, such as exponential, logarithmic, polynomial, power and moving averages, amongst others. Screening could also be possible using the angle of the linear line or the rate of change of slope.

Slope screening can be refined by calculation of the standard deviation of the values. A large standard deviation can indicate that the values are fluctuating rapidly, and may therefore not represent a reliable indication of performance of a company.

The initial step of slope screening provides an initial list of companies that meet or exceed requirements specified by a user. This list is then further refined by filtering to remove companies that fail to meet specific criteria. The final result set is a selection of companies that meet all relevant criteria, such as positive slopes, company data points and specific flags (e.g., a flag to indicate that the company is not an investment trust).

### User Interface and Adjustable Screening Parameters

A system that implements the invention in software must allow a user to input a range of requirements to control the manner in which companies will be selected. A display as shown in FIG. 5 can implement this requirement. These will now be described.

The ratio selector 10 is used to select the ratio or company data point for screening. For example, this may include some or all of (but is not limited to):

Return on Equity

Net Profit Margin

Return on Invested Capital

Return on Capital Employed

Return on Assets

Debt to Equity

Current Ratio

The timeframe selector 12 selects the timeframe for screening. For example, a 5 YR timeframe would use data from the latest available financial year of the selected ratio and the previous 4 years results. In 2012, this would generate a slope using data from 2011, 2010, 2009, 2008 and 2007.

Where YR indicates annual results and QTR indicates quarterly results a user might be given a choice of:

3 YR, 5 YR, 7 YR & 10 YR; or

6 QTR, 9 QTR, 12 QTR, 18 QTR, 24 QTR, 30 QTR

TTM

amongst other possibilities.

The screening type selector allows a user to select a screen based on either the slope or the latest financial data:

Slope selects the slope for the selected timeframe; or

Latest Figure selects the latest available financial result.

A results distribution histogram 16 displays the results of the selected universe. In the case of a ‘slope’ screening type values on the x-axis will be ‘slopes’. In the case of ‘Latest Figure’ screening type values on the x-axis will represent the actual company data point. The y-axis value represents the number of companies available for each value of x.

The system stores histogram results sets in a database, with the results being updated when new company data is released. For instance, for annual or quarterly data this update might occur one or more times per month. In addition, maximum and minimum values for each ratio slope will be stored in the database.

The display includes sliders 18 that can be manipulated by a user to reduce or to increase the number of companies by setting set the lower and upper limits of the company distribution.

A data range component 20 contains the result set under analysis. If ‘5 YR’ had been selected then the date range component 20 will show ‘Annual’ and the start and end report dates e.g. 2007 and 2011.

The number of companies field 22 displays numerically the number of companies available based on the selected lower/upper values that a user has selected.

Additional settings for the different parameters will be available through a dialog box launched when a settings button is pressed. This may, for example, be used to change the method of slope scanning from linear to parabolic.

### Margin of Safety

The concept of “margin of safety” is defined as the discount at which a stock is being traded below its intrinsic value. The system calculates this using the following formula:

$$Margin of Safety = \frac{Instrinsic value per share - Market price}{Instrinsic value per share} \qquad ( 2 )$$

where the intrinsic value per share is the sum of the discounted future cash flows of the company that can be expected to occur during the remaining life of the asset. This is illustrated in the diagram of FIG. 6.

### Intrinsic Value

Intrinsic value is calculated by discounting the future cash flows in two stages. Stage A is from year 1 (typically the present year) to year n (e.g. 10), and Stage B from year n+1 to perpetuity. The formula to calculate intrinsic value is

$$\begin{matrix}Intrinsic Value per share = \frac{Stage A dE + Stage B dE - Long Term Debt}{No . of Outstanding shares} & ( 3 ) \\ Stage A ( dE ) discounted Earnings = {\sum }_{1}^{n} CF \times \frac{{( 1 + GrwthA )}^{n}}{{( 1 + dRA )}^{n}} & ( 4 ) \\ Stage B ( dE ) discounted Earnings = \frac{\{ [ CF \times {( 1 + GrwthA )}^{n + 1} ] \text{/} ( dRB - GrwthB ) \}}{{( 1 + dRA )}^{n}} & ( 5 )\end{matrix}$$

where:

CF=Year 1 Cash Flow,

GrwthA=Growth expected in stage A,

GrwthB=Growth expected in stage B,

dRA=discount rate for stage A, and

dRB=discount rate for stage B.

### Growth

The estimation of growth of a company plays a key part in determining its intrinsic value. Growth can be either a fixed value, selected from a specific range (e.g. 5 YR Net Income Compound Average Growth Rate) or an entered formula.

$$Net Income C A G R = \{ {[ \frac{End Value}{Start Value} ]}^{[ \frac{1}{Number of periods} ]} \} - 1 \qquad ( 6 )$$

The values for the growth rate for Stage A would be based upon the selected timeframe e.g. 5 YR would mean the default values would be

GrwthA=Net Income CAGR over the previous 5 years

GrwthB=GrwthA/2

### Margin of Safety Requirements

Table 1 shows requirements are used by the screening module for Margin or Safety calculation. This component can be added to a template.

### Templates

Templates contain the criteria for selection and the results set. Standard templates are provided for the most common investment strategies e.g. Value Investing.

### Requirements

Table 2 shows additional requirements can be applied to the set of results returned by slope screening.

### Views

The final set of results is presented to the user as a view. Fields in a typical view are shown in Table 3.

### Ratios

A sample of ratios can be found in Table 4. Each row contains a different ratio. Each column represents a different piece of company reporting. Using return-on-equity as an example, the value ‘nom+’ appears in the ‘Net Income (After Tax)/Net Earnings’ column, the value ‘denom+’ appears in the ‘Total Equity (Owners' Equity)’ column. To calculate ROE, use the ‘Net Income’ as a positive nominator and ‘Total Equity’ as a positive denominator.

$$ROE = \frac{Net Income}{Total Equity} \qquad ( 7 )$$

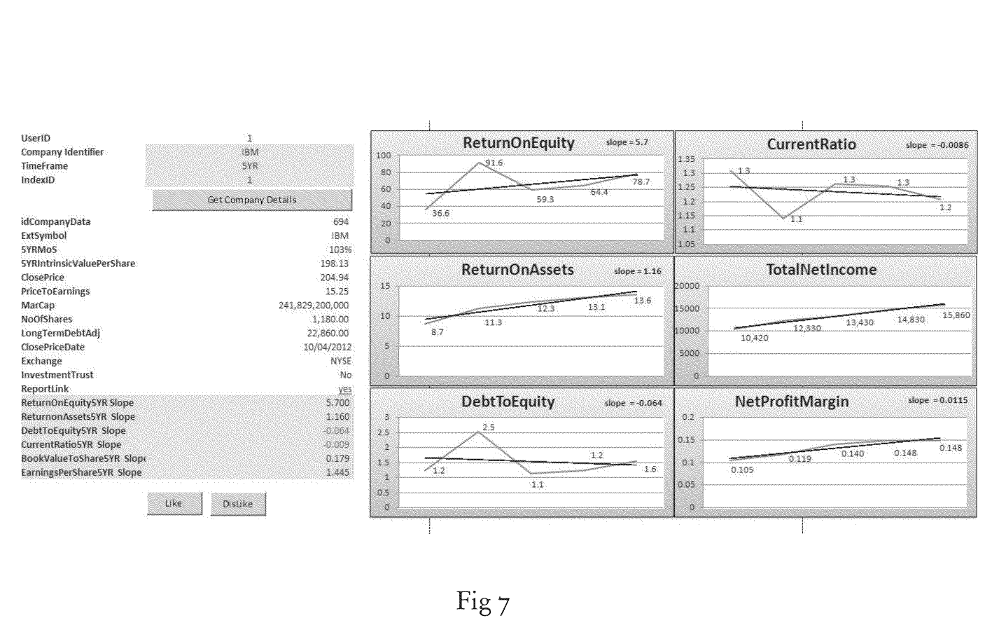

Once the process of slope screening has provided a user with a list of potentially valuable companies, the user will seek additional data on individual companies to arrive at an investment decision. To this end, embodiments of the invention allow a user to view multiple slopes relating to a particular company. One way that this information can be presented is shown in FIG. 7.

In addition to generation of slopes for companies being considered for investment, embodiments of the invention can generate slopes for companies in which a user has invested, and present these in a similar manner. Once an investment is made, the user indicates to the system that a company is in the user's portfolio. The system will calculate the slope for the entire portfolio based on a particular timeframe. The portfolio may consist of a selection of stocks or a selection of stocks and a vehicle which has as its underlying constituents a selection of stocks e.g. Exchange Traded (ETF) or Mutual Funds.

To further fine-tune their selection, a user can express their opinion on a particular company using a number of metrics e.g. by simply recording whether or not they like or dislike a company or using a scale from 1 to 10.

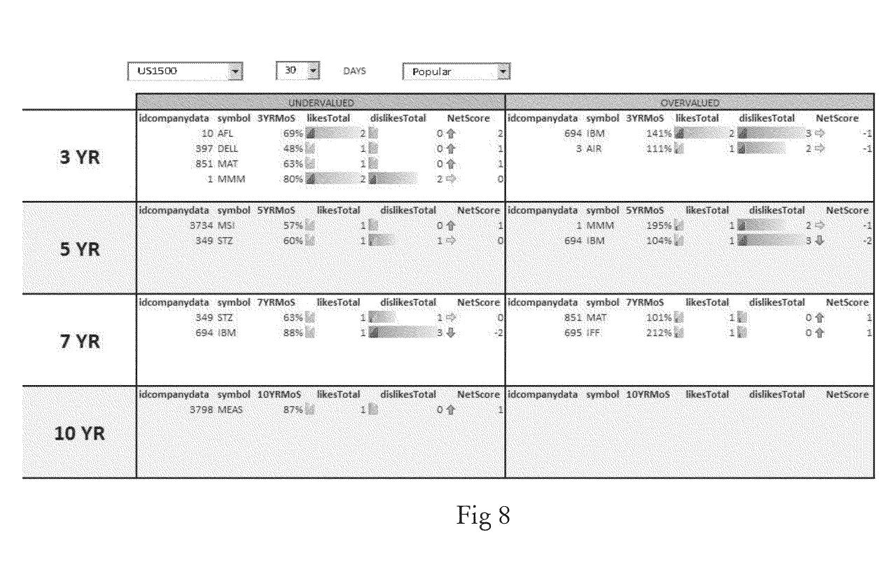

Once an initial screen and final selection has been completed, the results can be presented to a user in the form of a leaderboard’, as shown in FIG. 8. This allows a user to view the aggregated opinions of each user in a particular group. This leaderboard will present the aggregated view visually by listing the top 5 companies based upon a sum of the recorded metric for a community of several users of the system.

TABLE 1

| Name | Description | Values |
|---|---|---|
| Sliders | To reduce/increase the number of | Margin of Safety will |
| | companies the sliders can be | range from - 0% |
| | moved backwards and forwards to | to 250 |
| | set the lower/upper limits. | |
| Timeframe | Select relevant timeframe for | 3 YR, 5 YR, 7 YR & |
| selector | screening e.g. a 5 YR timeframe | 10 YR 3 QTR, 6 QTR, |
| | would select data from 2010 to | 9 QTR, 12 QTR |
| | 2006 | |
| | YR = annual results | |
| | QTR = based on quarterly results | |
| Results | The results view is a histogram of | |
| distribution | the selected universe. | |
| | Histograms results sets will be | |
| | stored in a database and updated | |
| | when new company data is | |
| | released. | |
| | Max/Min values for each ratio will | |
| | be stored in the db. | |
| Data range | This component contains the | |
| | result set under analysis. It ‘5 YR’ | |
| | has been selected then it will show | |
| | ‘Annual’ and the start and end | |
| | report dates e.g. 2006 and 2010 | |
| Settings | Growth calculation - user can set | Growth ratio could be |
| | the growth parameter for (in the | a derived from a |
| | case of the terminal IV method) for | number of different |
| | stage A and stage B. | figures e.g. |
| | | CAGR |
| | | CAGR/2 |
| | | 5 Year EPS |
| | Intrinsic Value calculation | A number of methods |
| | | exist to calculate the |
| | | IV, the following |
| | | Terminal Growth |
| | | Model |
| | Earning used | Net Income |
| | | Free Cash Flow |

TABLE 2

| Name | Description | Values |
|---|---|---|
| Select | To reduce/increase the number of | Margin of Safety |
| Universe | companies the sliders can be moved | will range from |
| | backwards and forwards to set the | 0% to 250% |
| | lower/upper limits. | |
| Add criteria | Adds a screening module to the | |
| | template | |
| Remove | Removes a screening module from | |
| | the template | |
| Companies | List of the companies who match all | Columns: |
| | criteria specified in the screening | Symbol |
| | modules. | Name |
| | | Intrinsic Value |
| | | (for selected |
| | | timeframe) |
| | | Margin Of Safety |
| | | Market Price |
| | | MarCap |
| | | Slope A e.g. ROE |
| | | Slope B e.g. NPM |
| | | GrwthA |
| | | Grwth B |
| | | Report Available |
| | | (if a qualitative |
| | | report is |
| | | available, click to |
| | | launch, if report |
| | | if unavailable a |
| | | ‘request report’ link |
| | | needs to be |
| | | available |
| Copy to | Copies company list to the active | |
| Portfolio | portfolio module | |

TABLE 3

| Name | Description | Values |
|---|---|---|
| Portfolio | List of companies. | Columns |
| | Companies can be | Consensus Rank - sum of ‘likes’ |
| | added by using the | minus ‘dislikes’ |
| | ‘Copy to Portfolio’ | Open Price - market price when |
| | function from a | company entered the portfolio |
| | template. | Open Date/Time |
| | | Symbol |
| | | Company Name |
| | | Price - today's price |
| | | % Change (Price - Open |
| | | Price)/Open Price |
| | | Currency |
| | | Gain/Loss |
| | | Remove - click to remove from |
| | | portfolio |
| | | Like - click to like |
| News | News feed filtered to | Columns |
| | only show the | Date |
| | companies contained | Symbol |
| | within the portfolio. | Headline |
| | Clicking on a new item | |
| | will launch a separate | |
| | window with the | |
| | news item. | |
| Discussion/ | Discussion board filtered | Columns |
| Ranking | to only show the | Symbol |
| | companies contained | Company Name |
| | within the portfolio. | Ranking - based on the number |
| | | of users who have added a |
| | | company to their portfolio |
| | | (+) - expansion option |
| | | Topic |
| | | Latest Post - time & date of the |
| | | latest post |
| | | Replies - No. Of replies |

What is claimed is:

1. A method for selecting companies for potential investment from a universe of companies, the method including a first screening step in which each company within the universe is subject to an analysis that determines the change of its results over a period of time, and those companies that have a change in performance that exceeds a threshold are selected for a second screening step in which those of the selected that have characteristics that meet specified requirements are presented to a user as prospects for investment.

2. The method of claim 1 in which the results analysed one or more of the return-on-equity, net profit-margin, return-on-invested-capital, return-on-capital-employed, return-on-assets, debt-to-equity or current ratio of the company.

3. The method of claim 1 in which the change in the results is calculated as a regression of a plurality of historical results.

4. The method of claim 3 in which the regression is one of a linear, exponential, logarithmic, polynomial, power or moving averages regression.

5. The method of claim 2 in which the regression is performed over a set of results that represent the performance of the company at fixed historical time intervals.

6. The method of claim 1 in which the period of time is several calendar quarters.

7. The method of claim 6 in which the results represent quarterly performance data of the company.

8. The method of claim 1 in which the period of time is several calendar years.

9. The method of claim 8 in which the results represent annual performance data of the company.

10. The method of claim 1 in which, in the second screening step, characteristics include data relating to the performance of each company identified in the first screening step.

11. The method of claim 1 in which, in the second screening step, characteristics include one or more flags that identify specific characteristics of each company.

12. The method of claim 1 further including presenting to a user a graphical display that shows the variation of a plurality of results of a company over time.

13. The method of claim 1 further including presenting to a user a graphical display that shows the variation of a plurality of results from a plurality of companies over time.

14. The method of any claim 13 in which the plurality of companies are companies in which a user has invested.

15. The method of claim 1 further including presenting to a user a graphical display that identifies those companies that have been assessed as having a favourable level of performance.

16. A computer software product according to claim 1 that performs a method in accordance with the first aspect of the invention when executed on a computer hardware platform.
